(19) United States
(12) Patent Application Publication
(10) Pub. No.: US 2026/0023304 A1
(43) Pub. Date: Jan. 22, 2026

(54) FRAME MODULE OF OPTICAL ACTUATOR DRIVEN BY SLIDING METHOD

(71) Applicant: SM TECH CO., LTD, Hwaseong-si (KR)

(72) Inventor: SANG HOON JANG, Suwon-si (KR)

(73) Assignee: SM TECH CO., LTD, Hwaseong-si (KR)

(21) Appl. No.: 19/269,175

(22) Filed: Jul. 15, 2025

(30) Foreign Application Priority Data
Jul. 16, 2024 (KR) 10-2024-0094015

(51) Int. Cl. G03B 13/36

(52) U.S. Cl. CPC G03B 13/36

(57) ABSTRACT

Disclosed is a frame module of an optical actuator, the frame module including a base, a carrier provided to be movable in an optical axis direction relative to the base, and first and second shaft rails disposed on one of the base and the carrier, wherein the first and second shaft rails are each disposed to extend in the optical axis direction and are spaced apart from each other by a predetermined distance in a direction orthogonal to the optical axis direction, wherein the other of the base and the carrier includes a rail guide part formed to extend in the optical axis direction, and both sides of the rail guide part respectively contact the first shaft rail and the second shaft rail during movement of the carrier.

### CROSS-REFERENCE TO RELATED APPLICATION

This application claims the benefit of Korean Patent Application No. 10-2024-0094015 filed on Jul. 16, 2024, in the Korean Intellectual Property Office, which is hereby incorporated by reference in its entirety.

### BACKGROUND OF THE INVENTION

The present invention relates to a frame module applied to an optical actuator, and more particularly, to a frame module having a structure capable of moving a carrier relative to a base without a ball.

In general, an optical module such as a small camera is mounted as a basic item in electronic devices, such as drones and vehicles, and in portable electronic devices such as smartphones, tablets, and laptops. Such an optical module has an actuator applied thereto and configured to implement an autofocus (AF) function of automatically adjusting a focal length between a subject and a lens by linearly moving the lens in the optical axis direction.

Korean Patent No. 10-2303499 (hereinafter referred to as “related art”) discloses an “optical actuator”. According to the related art, a magnet (or a coil) is installed in a carrier, which is a moving body equipped with a lens, and a coil (or a magnet) is installed in a housing, which is a fixed body. Thereafter, electromagnetic force is generated between the coil and the magnet, thereby enabling the carrier to be moved in the optical axis direction or in a direction perpendicular to the optical axis direction. In addition, a ball is interposed between the moving body and the fixed body such that an appropriate distance between the moving body and the fixed body is continuously maintained. Further, the carrier may be moved more flexibly and accurately by rotational movement of the ball and minimized friction through point contact between the ball and carrier.

However, in the related art, whenever an autofocus function and the like are repeatedly performed, the carrier may move a very short distance at a high speed while maintaining contact with a ball bearing and may be subject to strong external impact, the degree of which is similar to that of impact applied to the carrier when the carrier is dropped. Here, when the carrier is made of a synthetic resin, the surface of the carrier, which faces the ball bearing, is dented due to a surface hardness problem depending on the material properties, leading to deterioration in the autofocus function and the like.

In addition, a part of the carrier, which comes into contact with the ball (that is, a guide rail part), may be significantly worn, and flow marks or shrinkage formed by injection molding may adversely affect normal operation and durability of a product.

In addition, recently, a structural configuration of a product has become more complicated, and market demand has increased. Accordingly, the product has become larger such that load applied to the guide rail part increases. In consideration of such a situation, it is necessary to take measures against the above-mentioned problems.

### RELATED ART DOCUMENT

### Patent Document

(Patent Document 1) Korean Patent No. 10-2303499

### SUMMARY OF THE INVENTION

Therefore, the present invention has been made in view of the above problems, and it is an object of the present invention to provide a frame module applied to an optical actuator and configured to solve problems related to dents and marks formed in the rail surface that comes into contact with a ball provided in a conventional structure capable of implementing movement of a carrier through the ball.

It is another object of the present invention to provide a frame module configured to precisely control the position of a carrier, to maintain stable precision of the carrier, and to prevent distortion of the carrier due to impact.

It is still another object of the present invention to provide a frame module configured to increase a movement range of a carrier compared to a conventional structure using a ball.

It is a further object of the present invention to provide a frame module configured to reduce product cost by simplifying an assembly process.

In accordance with an aspect of the present invention, the above and other objects can be accomplished by the provision of a frame module of an optical actuator, the frame module including a base, a carrier provided to be movable in an optical axis direction relative to the base, and first and second shaft rails disposed on one of the base and the carrier, wherein the first and second shaft rails are each disposed to extend in the optical axis direction and are spaced apart from each other by a predetermined distance in a direction orthogonal to the optical axis direction.

The other of the base and the carrier includes a rail guide part formed to extend in the optical axis direction, and both sides of the rail guide part respectively contact the first shaft rail and the second shaft rail during movement of the carrier.

The rail guide part may include a first rail contact surface facing the first shaft rail, wherein the first rail contact surface is in line contact with the first shaft rail, and a second rail contact surface facing the second shaft rail, wherein the second rail contact surface is in line contact with the second shaft rail.

A rail installation groove may be formed in one surface of one of the base and the carrier.

Each of the first shaft rail and the second shaft rail may be partially embedded in one of the base and the carrier and may have an exposed portion in contact with the rail guide part within the rail installation groove. The rail guide part may include a protrusion disposed on one surface of the other of the base and the carrier, and at least a part of the protrusion may be inserted into the rail installation groove. The first and second rail contact surfaces may be provided on the protrusion. The first and second rail contact surfaces may be formed to be integrated with the protrusion.

The first and second rail contact surfaces may be made of metal.

The rail guide part may have a lubricant receiving groove formed to be more deeply recessed than the first and second rail contact surfaces and configured to receive a lubricant therein.

The rail guide part may include a guide shaft formed to extend in the optical axis direction, and both sides of the guide shaft may respectively contact the first shaft rail and the second shaft rail.

Each of the first shaft rail and the second shaft rail may be in line contact with the guide shaft. On an imaginary plane perpendicular to the optical axis direction, a first tangent line where the first shaft rail and the guide shaft contact each other and a second tangent line where the second shaft rail and the guide shaft contact each other may be disposed at an acute angle with respect to a center of the guide shaft.

One of the base and the carrier, having the first shaft rail and the second shaft rail installed thereon, may be made of a synthetic resin and may be injection-molded in a state in which the first shaft rail and the second shaft rail each made of metal are inserted.

In accordance with another aspect of the present invention, there is provided a frame module of an optical actuator, the frame module including a base, a carrier provided to be movable in an optical axis direction relative to the base, and a panel rail embedded in one of the base and the carrier, the panel rail comprising first and second rail parts each having at least a portion exposed from the one of the base and the carrier.

One of the base and the carrier may have protrusion formed on one surface thereof, the protrusion having a first rail contact surface and a second rail contact surface respectively formed on both sides thereof, and the first rail contact surface and the second rail contact surface may respectively contact the first rail part and the second rail part during movement of the carrier.

As is apparent from the above description, the present invention provides a frame module of an optical actuator, configured to disperse pressure applied to the frame module by changing a movement method of a carrier from a conventional point contact method using a ball to a line contact method using a shaft, thereby having an effect of preventing occurrence of marks and dents formed in the conventional structure, improving wear resistance of a portion in contact with the shaft, and increasing the lifespan of a product.

Additionally, the present invention guarantees a sufficient degree of straightness using a shaft, thereby having an effect of preventing driving vibration of an actuator and enabling precise operation.

In addition, the present invention has an effect of not only simplifying an assembly process and reducing costs by omitting a conventional ball assembly process, but also reducing defects by minimizing assembly variation.

Furthermore, the present invention uses a shaft rail or a panel rail instead of a conventional ball, thereby having an effect of increasing a movement distance of a carrier compared to the related art.

### BRIEF DESCRIPTION OF THE DRAWINGS

FIG. 1 is a view showing a first embodiment of a frame module applied to an optical actuator, where (a) is an assembly view of the frame module, and (b) is an exploded perspective view of the frame module;

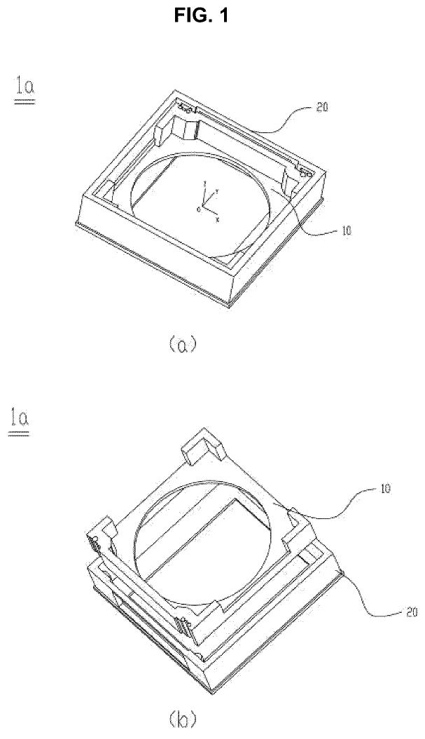

FIG. 2 is a plan view of the frame module shown in FIG. 1;

FIG. 3 is an enlarged view of portions A and B shown in FIG. 2;

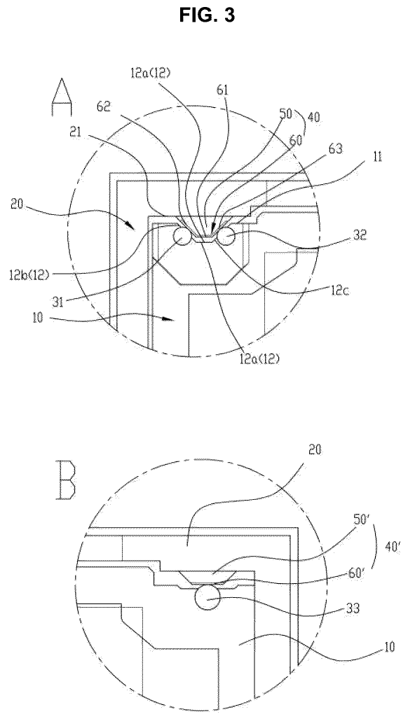

FIG. 4 is a view of the portions A and B shown in FIG. 2, when viewed from a different angle;

FIG. 5 is view showing a frame module according to a second embodiment of the present invention;

FIG. 6 is an enlarged view of portions A and B shown in FIG. 5;

FIG. 7 is a partial view of a frame module according to a third embodiment of the present invention;

FIG. 8 is a partial view of a frame module according to a fourth embodiment of the present invention;

FIG. 9 is a partial view of a frame module according to a fifth embodiment of the present invention;

FIG. 10 is a partial view of a frame module according to a sixth embodiment of the present invention;

FIG. 11 is a cross-sectional view of a conventional frame module; and

FIG. 12 is a view showing various embodiments of a shaft rail.

### DETAILED DESCRIPTION OF THE INVENTION

Hereinafter, technical ideas described in embodiments of the present invention may be implemented independently or may be implemented in combination with each other. In addition, the embodiments of the present invention will be described with reference to the accompanying drawings in the detailed description of the invention. However, the embodiments are merely exemplary, and it will be appreciated by those skilled in the art to which the present invention pertains that various modifications, equivalents, and other embodiments may be derived from the embodiments. Therefore, the true scope of technical protection of the present invention should be determined by the appended claims.

A frame module 1a according to an embodiment of the present invention is applied to an optical actuator and includes a carrier 10 and a base 20. The carrier 10 is provided to be movable relative to the base 20. Here, the frame module 1a includes a first shaft rail 31 and a second shaft rail 32 each configured to support movement of the carrier 10, and a rail guide part 40 guided by the shaft rails 31 and 32.

The carrier 10 may be provided to be movable in an optical axis direction Z relative to the base 20. The first and second shaft rails 31 and 32 are each formed to have a rod shape having a predetermined length and are disposed on either the carrier 10 or the base 20. Further, the first and second shaft rails 31 and 32 are disposed to extend in the optical axis direction Z and are spaced apart from each other by a predetermined distance in a direction X orthogonal to the optical axis direction Z. Each of the first and second shaft rails 31 and 32 may be made of metal.

Although not shown in the drawing, a lens and a magnet (or a coil) may be installed on the carrier 10, and a coil (or a magnet) may be installed on the base 20.

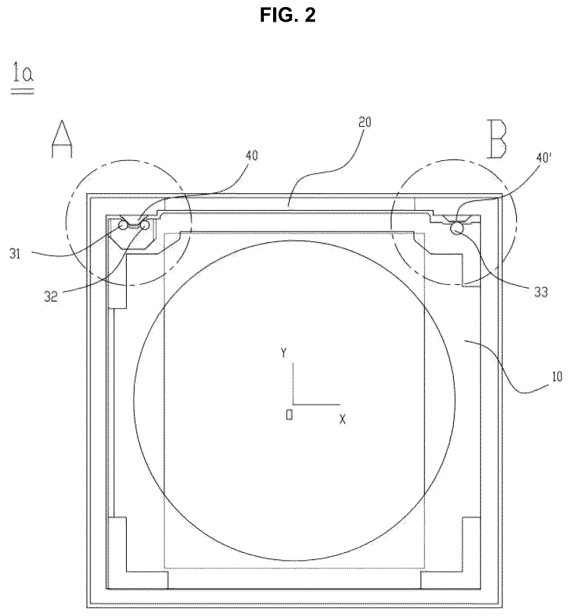

The carrier 10 is moved in the optical axis direction Z by electromagnetic force generated between the coil and the magnet. In this case, in order to facilitate smooth movement of the carrier 10 in the optical axis direction Z, the first and second shaft rails 31 and 32 may be disposed on one of the base 20 and the carrier 10, and the rail guide part 40 that is moved relative to the first and second shaft rails 31 and 32 may be provided on the other thereof. In the embodiment, the shaft rails 31 and 32 are provided on the carrier 10, and the rail guide part 40 is provided on the base 20. A structure in which a pair of the shaft rails 31 and 32 and the rail guide part 40 support each other may be applied to any one of the corners of the frame module 1a (a portion indicated with “A” in FIG. 2).

The base 20 may be formed to surround the carrier 10. The first and second shaft rails 31 and 32 may be disposed on an outer circumferential surface 11 of the carrier 10, and the rail guide part 40 may be disposed on an inner circumferential surface 21 of the base 20.

The rail guide part 40 is formed to extend in the optical axis direction Z, and both sides thereof respectively contact the first shaft rail 31 and the second shaft rail 32 during movement of the carrier 10.

The rail guide 40 may include a first rail contact surface CS1 facing the first shaft rail 31. The first rail contact surface CS1 may be in line contact with the first shaft rail 31. In other words, a portion at which the first rail contact surface CS1 and the first shaft rail 31 contact each other may form a single line.

The first rail contact surface CS1 may be formed to have a flat surface, and the first shaft rail 31 may be formed to have a circular cross section.

The rail guide part 40 may include a second rail contact surface CS2 facing the second shaft rail 32. The second rail contact surface CS2 may be in line contact with the second shaft rail 32.

A rail installation groove 12 may be formed in one surface of one of the base 20 and the carrier 10. The rail guide part 40 may include a protrusion 50 disposed on one surface of the other of the base 20 and the carrier 10. At least a part of the protrusion 50 may be inserted into the rail installation groove 12. Hereinafter, as in the embodiment, the rail guide part 40 is disposed on the inner circumferential surface of the base 20, and the first and second shaft rails 31 and 32 are disposed on the outer circumferential surface of the carrier 10.

The first shaft rail 31 and the second shaft rail 32 are partially embedded in the carrier 10. Here, portions of the first shaft rail 31 and the second shaft rail 32, exposed within the rail installation groove 12, may be in contact with the rail guide part 40. Specifically, the rail installation groove 12 may include a bottom surface 12a and first and second groove inner surfaces 12b and 12c respectively obliquely extending from both sides of the bottom surface 12a to form an entrance through which the protrusion 50 is inserted. The first groove inner surface 12b and the second groove inner surface 12c may be obliquely formed to be gradually spaced apart from each other in a direction from the bottom surface 12a toward the entrance. The first groove inner surface 12b and the second groove inner surface 12c may be disposed symmetrically on both sides of the bottom surface 12a.

The first shaft rail 31 may have an exposed portion on the first groove inner surface 12b, and the second shaft rail 32 may have an exposed portion on the second groove inner surface 12c.

The first and second rail contact surfaces CS1 and CS2 may be provided on the protrusion 50. The first and second rail contact surfaces CS1 and CS2 may be formed on a metal panel 60. Specifically, the metal panel 60 may be a metal plate having a predetermined thickness and may be partially embedded in the protrusion 50.

The metal panel 60 may include a first panel part 61 having a surface facing the bottom surface 12a of the rail installation groove 12, and a second panel part 62 and a third panel part 63 respectively bent from both sides of the first panel part 61 to form the first rail contact surface CS1 and the second rail contact surface CS2.

However, the present invention is not limited thereto. According to the embodiment, the first rail contact surface CS1 and the second rail contact surface CS2 may be formed of separate metal panels.

Meanwhile, the base 20 may be formed by injecting a synthetic resin. In this case, the metal panel 60 may be inserted into a mold provided for formation of the base 20, and then a resin may be injected into the mold to form the base 20.

The first rail contact surface CS1 may face the first groove inner surface 12b and may be spaced apart from the first groove inner surface 12b by a predetermined gap. The second rail contact surface CS2 may face the second groove inner surface 12c and may be spaced apart from the second groove inner surface 12c by a predetermined gap.

Alternatively, the first and second rail contact surfaces CS1 and CS2 may be formed to be integrated with the protrusion 50. In this case, the metal panel 60 does not need to be provided, and the first and second rail contact surfaces CS1 and CS2 form e surface of the protrusion 50.

Meanwhile, the rail guide part 40 may have one or more lubricant receiving grooves 65a, 65b, and 65c formed to be more deeply recessed than the first and second rail contact surfaces CS1 and CS2 and configured to receive a lubricant therein. A plurality of lubricant receiving grooves 65a, 65b, and 65c may be disposed spaced apart from each other in the optical axis direction Z. Each of the lubricant receiving grooves 65a, 65b, and 65c may be formed by a portion cut through the metal panel 60. Depending on the embodiment, a groove may be formed in a portion of the protrusion 50, which corresponds to the cut portion. In this case, each of the lubricant receiving grooves 65a, 65b, and 65c may extend from an entrance formed by the cut portion of the metal panel 60 to a bottom portion of the groove formed in the protrusion 50.

Meanwhile, according to the embodiment, when the first and second rail contact surfaces CS1 and CS2 are formed to be integrated with the protrusion 50, each of the lubricant receiving grooves 65a, 65b, and 65c may be formed as a groove recessed from the surface of the protrusion 50.

Meanwhile, when the above-described structure in which the first and second shaft rails 31 and 32 and the rail guide part 40 support each other is applied to one corner A of the module frame 1a, the first and second shaft rails 31 and 32 respectively contact both sides of the rail guide part 40. As a result, the rail guide part 40 may be stably supported without shaking in the direction X in which the first and second shaft rails 31 and 32 are spaced apart from each other. Therefore, only one shaft rail 33 may be provided at a corner B adjacent to the corner A in the direction X in which the first and second shaft rails 31 and 32 are spaced apart from each other.

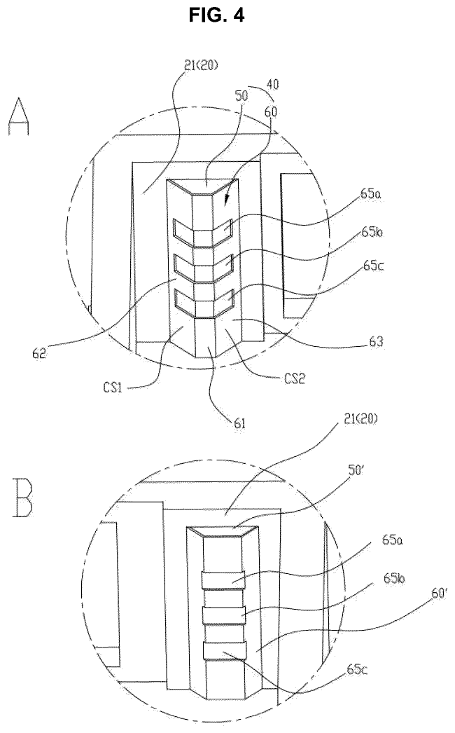

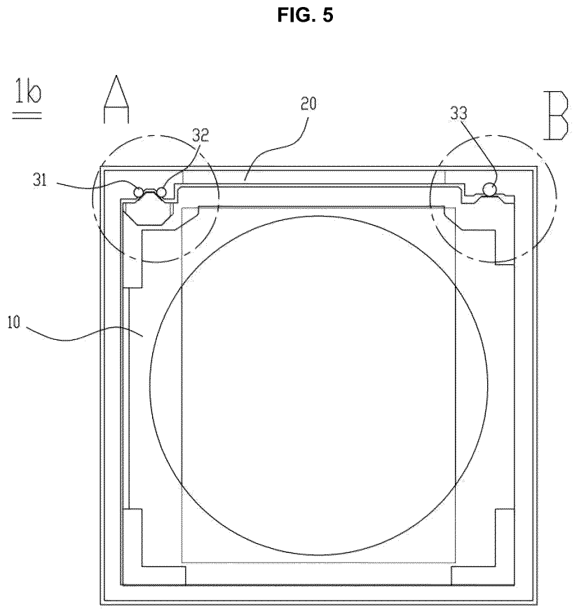

Specifically, as shown in FIGS. 4 and 5, at the corner B, one rail shaft 33 may be provided on the outer circumferential surface of the carrier 10, and a rail guide part 40′ having a rail contact surface in contact with the rail shaft 33 may be provided on the inner circumferential surface of the base 20.

The rail guide part 40′ may include a protrusion 50′. The rail contact surface may be formed by a metal panel 60′ and may be fixed to the protrusion 50′. Alternatively, the surface of the protrusion 50′ may directly form the rail contact surface.

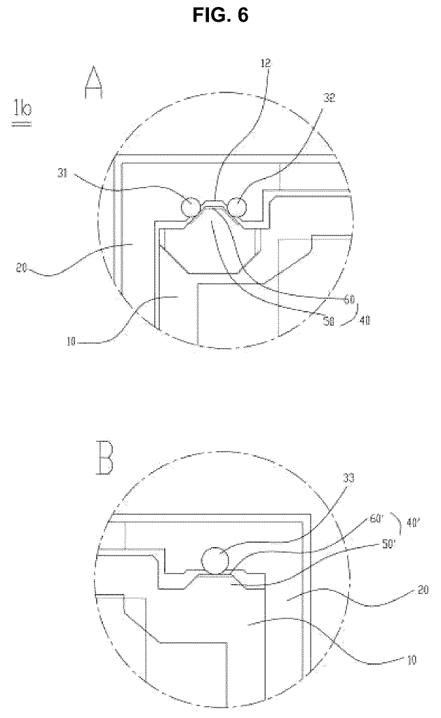

Furthermore, similarly to the above-described lubricant receiving grooves 65a, 65b, and 65c, lubricant receiving grooves 65a′, 65b′, and 65c′ may be formed in the rail guide part 40′. Since such a structure is substantially the same as the lubricant receiving grooves 65a, 65b, and 65c, a description thereof will be omitted. FIG. 5 is a view showing a frame module according to a second embodiment of the present invention. FIG. 6 is an enlarged view of portions A and B shown in FIG. 5.

Referring to FIGS. 5 and 6, in a frame module 1b according to the second embodiment of the present invention, contrary to the above-described embodiment, the first and second shaft rails 31 and 32 are disposed on the inner circumferential surface of the base 20, and the rail guide part 40 is disposed on the outer circumferential surface of the carrier 10. Hereinafter, the same configurations as described above will be denoted by the same reference numerals, and a redundant description thereof will be omitted.

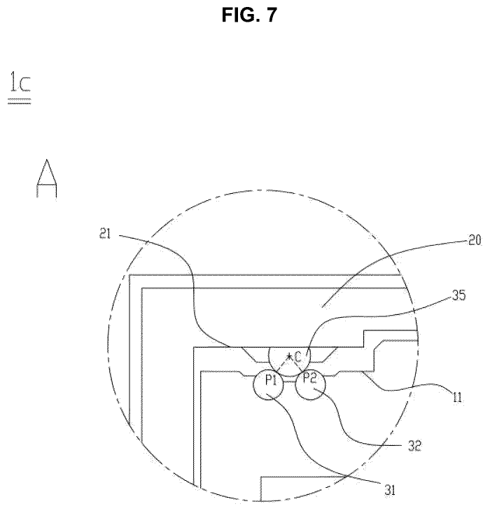

FIG. 7 is a partial view of a frame module according to a third embodiment of the present invention. Referring to FIG. 7, a frame module 1c according to the third embodiment of the present invention includes the first and second shaft rails 31 and 32 and the rail guide part 40.

The first and second shaft rails 31 and 32 are disposed on one of the base 20 and the carrier 10 and are each formed to extend in the optical axis direction Z. Here, the first and second shaft rails 31 and 32 are spaced apart from each other by a predetermined gap in the direction X orthogonal to the optical axis direction Z. The rail guide part 40 includes a guide shaft 35 formed to extend in the optical axis direction Z, and both sides of the guide surface 35 respectively contact the first and second shaft rails 31 and 32. The guide shaft 35 may be made of metal.

Each of the first and second shaft rails 31 and 32 may be partially embedded in the outer circumferential surface of the carrier 10, and the guide shaft 35 may be partially embedded in the inner circumferential surface of the base 20. Here, the base 20 and/or the carrier 10 may be injection-molded by injecting a resin in a state in which the first and second shaft rails 31 and 32 and the guide shaft 35 are inserted into a mold.

Each of the first and second shaft rails 31 and 32 may be in line contact with the guide shaft 35. The first shaft rail 31, the second shaft rail 32, and the guide shaft 35 may each have a circular cross section.

On an imaginary plane perpendicular to the optical axis, a first tangent line P1 where the first shaft rail 31 and the guide shaft 35 are in contact with each other and a second tangent line P2 where the second shaft rail 32 and the guide shaft 35 are in contact with each other may be disposed at an acute angle with respect to a center C of the guide shaft 35.

Since both sides of the guide shaft 35 are in contact with the first shaft rail 31 and the second shaft rail 32, the guide shaft 35 may be stably supported without shaking in a direction in which the first and second shaft rails 31 and 32 are spaced apart from each other.

Meanwhile, FIG. 7 shows a corner A of the frame module 1c, and the same structure may be applied to a corner B as well.

In addition, depending on the embodiment, the first and second shaft rails 31 and 32 may be disposed on the inner circumferential surface of the base 20, and the guide shaft 35 may be disposed on the outer circumferential surface of the carrier 10.

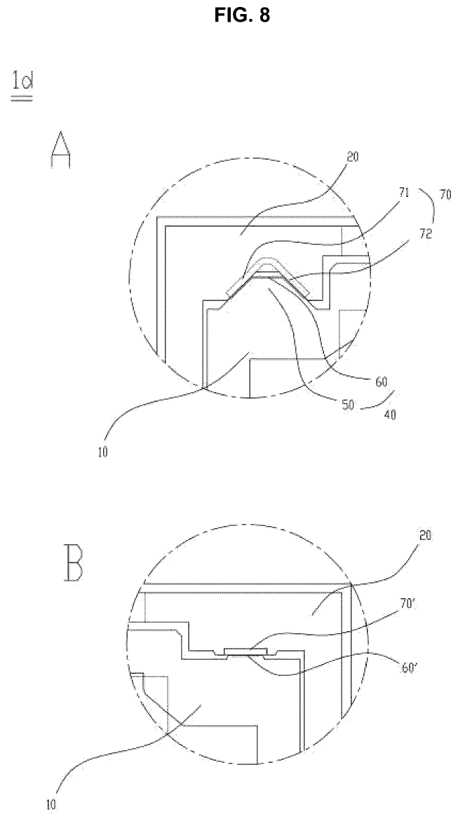

FIG. 8 is a partial view of a frame module according to a fourth embodiment of the present invention. Referring to FIG. 8, a frame module 1d according to the fourth embodiment of the present invention includes the base 20, the carrier 10 provided to be movable in the optical axis direction Z relative to the base 20, and a panel rail 70 partially embedded in any one of the base 20 and the carrier 10. The panel rail 70 may be made of metal. Hereinafter, the panel rail 70 will be described as being disposed on the inner circumferential surface of the base 20.

The panel rail 70 may be disposed at the corner A. The panel rail 70 is partially embedded in the base 20. The panel rail 70 may be manufactured by insert molding in the same manner as in the above-described embodiments.

The panel rail 70 may include first and second rail parts 71 and 72. Each of the first rail part 71 and the second rail part 72 has a portion exposed to the outside of the base 20. The panel rail 70 may be bent along a predetermined folding line parallel to the optical axis direction Z, and the first rail part 71 and the second rail part 72 may be respectively provided on both sides of the folding line. The panel rail 70 may be bent in an approximately “ [symbol] ” shape.

The first rail part 71 and the second rail part 70 have portions exposed to the outside of the base 20, and these exposed portions contact the first rail contact surface CS1 and the second rail contact surface CS2, which will be described later, respectively.

The carrier 10 may include the rail guide part 40. As in the above-described embodiments, the rail guide part 40 may include the protrusion 50 and the metal panel 60.

The first and second rail contact surfaces CS1 and CS2 may be provided on the protrusion 50. The first and second rail contact surfaces CS1 and CS2 may be formed on the metal panel 60. The metal panel 60 is a metal plate having a predetermined thickness and may be partially embedded in the protrusion 50.

The metal panel 60 may include the first panel part 71, and the second panel part 72 and the third panel part 73 respectively bent from both sides of the first panel part 71 to form the first rail contact surface CS1 and the second rail contact surface.

Alternatively, the first and second rail contact surfaces CS1 and CS2 may be formed to be integrated with the protrusion 50. In this case, the metal panel 60 does not need to be provided, and the first and second rail contact surfaces CS1 and CS2 form the surface of the protrusion 50.

Meanwhile, at the corner B, a flat panel rail 70′ may be disposed on the inner circumferential surface of the base 20, and a flat metal panel 60′ in contact with the panel rail 70′ may be provided on the outer circumferential surface of the carrier 10.

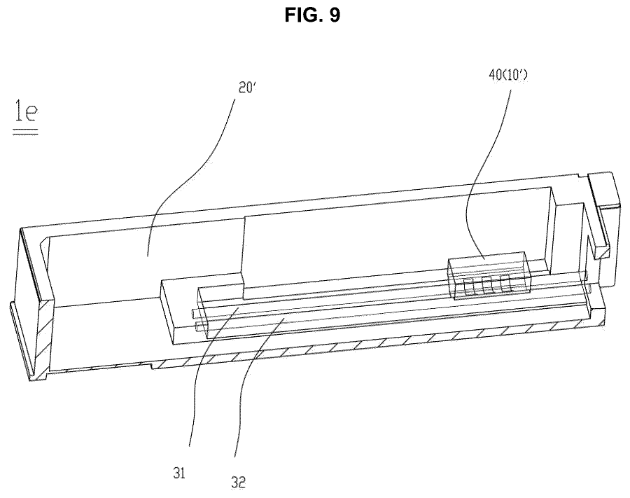

FIG. 9 is a partial view of a frame module 1e according to a fifth embodiment of the present invention. Referring to FIG. 9, a carrier (not shown) may be provided to be movable in a horizontal direction. In this case, the optical axis direction Z is the horizontal direction. A base 20′ shown in FIG. 9 includes the first and second shaft rails 31 and 32 aligned in the horizontal direction and configured to guide horizontal movement of the carrier. Further, the rail guide part 40 is provided on the carrier.

The first and second shaft rails 31 and 32, an installation structure thereof, and a detailed configuration of the rail guide part 40 are substantially the same as those described above, SO a detailed description thereof will be omitted.

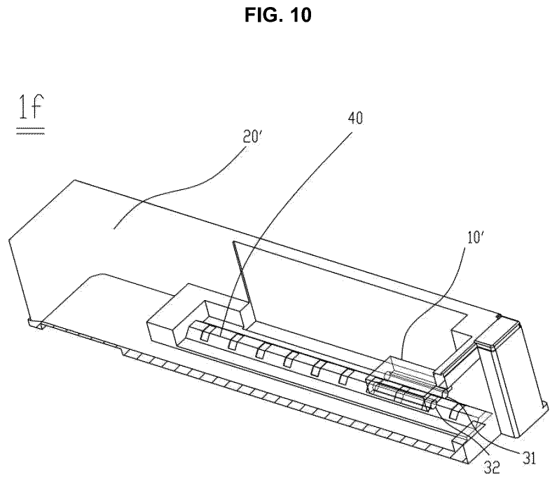

FIG. 10 is a partial view of a frame module 1f according to a sixth embodiment of the present invention. Referring to FIG. 10, in the frame module 1f according to the sixth embodiment of the present invention, the rail guide part 40 is provided on the base 20′, and the first and second shaft rails 31 and 32 are provided on a carrier 10′. Here, only a part of the carrier 10′ is shown to avoid complexity in the drawing.

The first and second shaft rails 31 and 32, an installation structure thereof, and a detailed configuration of the rail guide part 40 are substantially the same as those described above, so a detailed description thereof will be omitted.

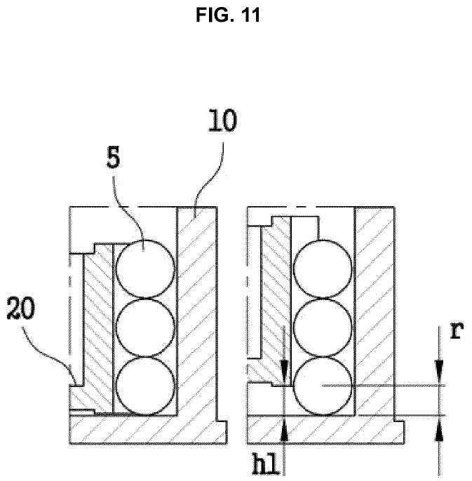

FIG. 11 is a cross-section of a conventional frame module. Referring to FIG. 11, in a conventional structure in which the carrier 20 is moved relative to the base 10 in a point contact manner using the ball 5 interposed therebetween, a driving range h1 in which the carrier 20 is maximally separated from the bottom of the base 10 may not be equal to or greater than a radius r of the ball 5. The reason for this is that the ball 5 deviates from the original position thereof when the driving range h1 is equal to or greater than the radius r.

The present invention has an advantage of providing a longer driving range than that of the conventional structure because the shaft rails 31 and 32 or the panel rail 70 are in contact with a counterpart without using the ball 5.

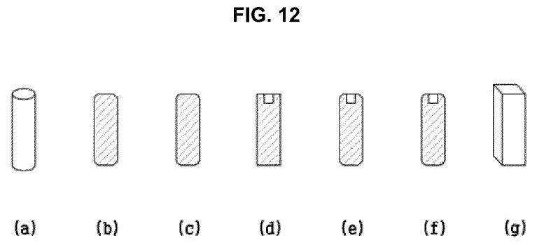

FIG. 12 is a view showing various embodiments of the shaft rail, where (a) and (g) are perspective views of the shaft rails according to the embodiments, and (b) to (f) are longitudinal cross-sections of the shafts according to the embodiments.

Referring to FIG. 12, each of the shaft rails 31 and 32 may have a cylindrical shape (a), a shape (b) formed by chamfering corners of the upper and lower ends of the cylindrical shape, a shape (c) formed by rounding corners of the upper and lower ends of the cylindrical shape to impart a curvature to each corner, a shape (d) having a groove formed in one end of the cylindrical shape, a shape (e) formed in such a manner that one end of the cylindrical shape has a groove provided therein and configured for a stopper to be inserted thereinto and a corner surrounding the groove is chamfered, a shape (f) formed in such manner that one end of the cylindrical shape has a groove provided therein and configured for a stopper to be inserted thereinto and a corner surrounding the groove is rounded to impart a curvature to the corner, or a shape (g) of a square pillar (preferably, the cross section of the shape is a rectangular or a square).

The technical ideas described in the embodiments of the present invention may be implemented independently or may be implemented in combination with each other. In addition, the embodiments of the present invention have been described with reference to the accompanying drawings in the detailed description of the invention. However, the embodiments are merely exemplary, and it will be appreciated by those skilled in the art to which the present invention pertains that various modifications, equivalents, and other embodiments may be derived from the embodiments. Therefore, the true scope of technical protection of the present invention should be determined by the appended claims.

1. A frame module of an optical actuator, the frame module comprising:
a base;
a carrier provided to be movable in an optical axis direction relative to the base; and
first and second shaft rails disposed on one of the base and the carrier, wherein the first and second shaft rails are each disposed to extend in the optical axis direction and are spaced apart from each other by a predetermined distance in a direction orthogonal to the optical axis direction,
wherein the other of the base and the carrier comprises a rail guide part formed to extend in the optical axis direction, wherein both sides of the rail guide part respectively contact the first shaft rail and the second shaft rail during movement of the carrier,
wherein the rail guide part comprises:
a first rail contact surface facing the first shaft rail, wherein the first rail contact surface is in line contact with the first shaft rail; and
a second rail contact surface facing the second shaft rail, wherein the second rail contact surface is in line contact with the second shaft rail.

2. (canceled)

3. The frame module according to claim 1, wherein
a rail installation groove is formed in one surface of one of the base and the carrier,
each of the first shaft rail and the second shaft rail is partially embedded in one of the base and the carrier and has an exposed portion in contact with the rail guide part within the rail installation groove,
the rail guide part comprises a protrusion disposed on one surface of the other of the base and the carrier, wherein at least a part of the protrusion is inserted into the rail installation groove, and
the first and second rail contact surfaces are provided on the protrusion.

4. The frame module according to claim 3, wherein the first and second rail contact surfaces are formed to be integrated with the protrusion.

5. The frame module according to claim 3, wherein the first and second rail contact surfaces are made of metal.

6. The frame module according to claim 4 or 5, wherein the rail guide part has a lubricant receiving groove formed to be more deeply recessed than the first and second rail contact surfaces and configured to receive a lubricant therein.

7. A frame module of an optical actuator, the frame module comprising:
a base;
a carrier provided to be movable in an optical axis direction relative to the base; and
first and second shaft rails disposed on one of the base and the carrier, wherein the first and second shaft rails are each disposed to extend in the optical axis direction and are spaced apart from each other by a predetermined distance in a direction orthogonal to the optical axis direction,
wherein the other of the base and the carrier comprises a rail guide part formed to extend in the optical axis direction, wherein both sides of the rail guide part respectively contact the first shaft rail and the second shaft rail during movement of the carrier,
wherein the rail guide part comprises a guide shaft formed to extend in the optical axis direction, wherein both sides of the guide shaft respectively in line contact with the first shaft rail and the second shaft rail.

8. The frame module according to claim 7, wherein
on an imaginary plane perpendicular to the optical axis direction, a first tangent line where the first shaft rail and the guide shaft contact each other and a second tangent line where the second shaft rail and the guide shaft contact each other are disposed at an acute angle with respect to a center of the guide shaft.

9. The frame module according to claim 1, wherein one of the base and the carrier, having the first shaft rail and the second shaft rail installed thereon, is made of a synthetic resin and is injection-molded in a state in which the first shaft rail and the second shaft rail each made of metal are inserted.

10. (canceled)

11. The frame module according to claim 5, wherein the rail guide part has a lubricant receiving groove formed to be more deeply recessed than the first and second rail contact surfaces and configured to receive a lubricant therein.

12. The frame module according to claim 7, wherein one of the base and the carrier, having the first shaft rail and the second shaft rail installed thereon, is made of a synthetic resin and is injection-molded in a state in which the first shaft rail and the second shaft rail each made of metal are inserted.
